(19) United States
(12) Patent Application Publication
(10) Pub. No.: US 2009/0013954 A1
(43) Pub. Date: Jan. 15, 2009

(54) AIR FEED APPARATUS OPERATING WITH VACUUM IN INTERNAL COMBUSTION ENGINES

(76) Inventor: MELIH OLCAY, Istanbul (TR)

Correspondence Address: DYKAS, SHAVER & NIPPER, LLP, P.O. BOX 877, BOISE, ID, 83701-0877, US

(21) Appl. No.: 11/775,322

(22) Filed: Jul. 10, 2007

(51) Int. Cl. F02M 35/104

(52) U.S. Cl. 123/184.47

(57) ABSTRACT

In the internal combustion engines the technique of air feed operating with vacuum is important in view of the meeting of increasing and decreasing air-oxygen demand varying according to the change of revolution. While causing engine failure and increase of heat at low revolution with excess air-oxygen, it causes high fuel consumption at high revolution with less air-oxygen. In order for the fuel to be fully combusted, it provides sufficient air-oxygen during all revolutions, from the lowest to the highest, in correct proportion with the suction of the vacuum by the engine.

Our invention is a study with the aim of obtaining fuel economy by decreasing fuel consumption through increasing efficiency in all vehicles consuming petroleum based fuel and reducing environmental hazards to a minimum.

The technical field and the known status of the technique of our invention are as follows.

Numerous studies have been made towards increasing the efficiency in internal combustion engines. For example, systems which increase the efficiency and performance of the engine operating with the principle of burning the fuel with enriched oxygen by feeding additional air/oxygen to the engine like in Turbo and Super Charger systems are known and widely utilized.

Turbo system is a system operating by revolving a second turbine through a rod by the force created by a turbine turnover of the pushing power generated by exhaust waste gasses and thus sending the fresh air compressed by pressure to the combustion chambers.

Whereas Super Charger operates by transferring to the combustion chamber pressurized air produced and compressed in a screwed compressor of a power transferred from the engine through a belt or a chain.

Fundamentally both systems operate with the principle of obtaining high efficiency through better consumption of the fuel by charging additional air/oxygen.

Both systems consume a portion of the energy they produce, around 30%, as friction, mechanical stress and heat loss incurred during the compression of the air. The stress created on the engine by the compressed air manifests itself as over heat and metal ware. These effects are trying to be reduced by additional cooling systems. On the other hand, the effect of these systems designed for performance purposes is limited since they consume high quantity of air/oxygen together with high quantity of fuel composures.

The technical problem aimed to be solved by our invention is to obtain fuel economy by decreasing fuel consumption through increasing performance and efficiency in the 4 gear internal combustion engines. The most effective method to obtain the aimed goal is to increase the efficiency of the engine through total combustion of the fuel consumed. The thing to be done to increase the efficiency is to enrich only the oxygen in the fuel/oxygen consumed by the engine.

The difference of our invention from the other existing air feed systems is utilization of negative pressure instead of high pressure during feeding of air/oxygen to the pistons. According to the dynamics of fluids air moves from high pressure towards low pressure. Despite the fact that the external environmental pressure is of very low grade like nearly 1 atm. at sea level, since it is greater than negative pressure, the air is moved and sucked towards inside of the engine from external environment. During this procedure there is no self power consumption by the passive operating apparatus. There is no increase in heat and load on the engine arising from the performance flow of the apparatus. The procedure of feeding additional air/oxygen under vacuum control and in quantities increasing and decreasing according to the variations in the engine revolution does not cause over heat or engine failure. Since the fuel in minimum quantity mixed with enriched air/oxygen obtains maximum yield and high drive power during fuel combustion, performs the same operation with less fuel and as a result the fuel consumption of the engine decreases. Noticeable decrease is observed through full combustion of harmful emission gasses.

The view of the air feed apparatus operating with vacuum realized to reach the aim of the invention has been drawn on the attachments

And according to these drawings;

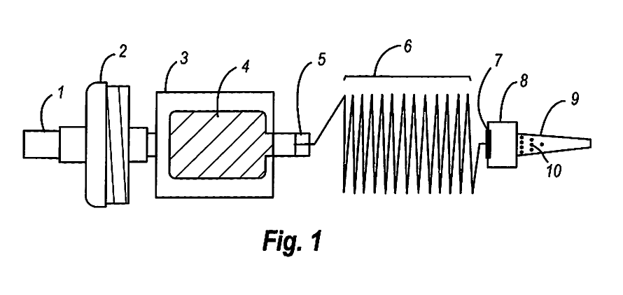

FIG. 1. The view of the internal cross section from the top.

FIG. 2. The view of the external cross section from the top.

Explanation of the technical structure and operation of the invention:
1. Air Feed Hose
2. Aluminum Lid I.
3. Acoustic Pump
4. Filter
5. Reducer I
6. Vacuum Accelerator
7. Reducer II
8. Expansion Container
9. Air Suction Nozzle
10. Air Entrance of Internal System
11. Aluminum Lid II
12. Aluminum Pipe
13. Aluminum Ring
14. Stabilizing Screw
15. Air Entrance of External System

We can define the technical explanation of our invention as follows: The apparatus obtaining fuel economy through air feed operating with vacuum in 4 gear engines.

The system is formed by bringing together Aluminum Lid II (11) installed in Aluminum pipe (12), Aluminum Lid I (2), Air suction nozzle (9), Expansion Container (8), Reducer II (7), Vacuum Accelerator (6), Reducer I (5), Acoustic Pump (3), Filter (4), Air Feed Hose (1), Aluminum Ring (13), Stabilizing Screw (14).

In the design of the system, the principle of increasing the speed and pressure by narrowing the pipe diameter and decreasing the speed and pressure by enlarging the pipe diameter of the fluid moving inside the pipe has been taken as basis in accordance with fluid dynamics. The wave and kinetic energy created during the flow of the system provides additional contribution for increasing the efficiency of the system.

A detailed explanation of our invention is as follows. In addition to provision of external protection, by functioning as pressure tube, the tube formed by Aluminum Pipe (12), Aluminum Lid II (11) and Aluminum Lid I (2) prevents the fast feeding efforts of the external air with positive pressure of the vacuum produced by the engine. While allowing entry of controlled air inside the tube, it also preserves the difference of pressure at the same time. The air at normal atmospheric pressure in the external environment is let in through the 3 external system air entrances of 4 mm. Diameter by sucking through the 1 mm. space between the aluminum ring (13) and external system air entrance (15) by moving towards the negative pressure produced by the engine in accordance with fluid dynamics. The air sucked into the aluminum pipe (12) is hereafter below vacuum. The air which passes through the 8, 0.8 mm diameter internal system air entrances (10) existing in the air suction nozzle (9) passes from the 1 mm. diameter outlet of the air suction nozzle (9) into the 10 mm. diameter expansion container (8) and slows down and with the assistance of reducer II (7) the diameter of the pipe is again decreased and connected to the vacuum accelerator (6). Here the air is sucked through the vacuum accelerator (6) produced of a hose of 3 m. length and 1 mm. inside diameter. While this operation decreases the amount of air, it increases the speed and kinetic energy of the air. The high speed kinetic energy of the air is transformed into wave energy by letting the accelerated air crash to the walls of the Acoustic Pump (3) through the Filter (4) with the assistance of reducer I (5). The air, by moving along the produced wave vibrations, fills into the air suction manifold of the engine and to the pistons thereafter through the air feed hose (1).

Despite the fact that the quantity of air filled into the pistons is low; the air sucked in by relatively high vacuum is not equal to the volume of air in normal atmospheric pressure since it is formed under very low atmospheric pressure. The air molecules get closer to each other under vacuum and become dense by minimizing the distance between them. This operation is a complete opposite of the density operation of the air molecules through compaction by pressure. During the normal operation of the engine, the Standard air-fuel mixture filled into the air suction system is mixed with the dense air produced under vacuum created by the apparatus and enriches the oxygen existing in the mixture and thus obtains full combustion. During this operation, the compacted dense air provided by the apparatus expands and as a result provides increase of pressure in the pistons and increase of volumetric yield at the same rate.

The aim of our invention is to obtain benefit in firstly fuel economy and the subjects of decreasing the amount of harmful emission gasses and obtain more horse and hauling power in automobiles with small size engines especially in the automotive and transportation industries. In addition, we believe that the apparatus will be widely used due to the advantages provided by the design specialty together with economical production cost, operating with any kind of fuel derived from petroleum and again easily applicable to all model and make vehicles.

1. An apparatus for providing fuel economy through air feed operating with vacuum in 4 gear internal combustion engines, said apparatus comprising an Aluminum Pipe (12), Aluminum Lid II (11), and Aluminum Lid I (2), installed in a tube, Air Suction Nozzle (9), Expansion Container Hose (8), Reducer II (7), Vacuum Accelerator (6), Reducer I (5), Acoustic Pump (3), Filter (4), Aluminum Lid I (2), Aluminum Lid II (11), Air Feed Hose (1), Aluminum Ring (13), and a Stabilizer Screw (14).

2. The apparatus of claim 1 wherein the external protection of the apparatus is an aluminum pipe (12) separating the external and the internal pressure with a diameter of 6 cm and length of 25 cm with a wall thickness of 2 mm.

3. The apparatus of claim 1 wherein said Air Suction Nozzle (9) has a length of 2 cm and diameter of 7 mm, said Air Suction Nozzle produced from conic type plastic resistant to high heat, said Air Suction Nozzle having eight air entrances with 0.8 mm diameter each.

4. The apparatus of claim 1 wherein said Expansion Container (8) is in the form of a pipe with both ends open, said pipe produced from plastic resistant to high heat, said pipe with a diameter of 10 mm and length of 2 cm.

5. The apparatus of claim 1 wherein said Reducer II (7) has a 10 mm outside and a 1 mm inside diameter, said Reducer II produced from plastic resistant to high heat.

6. The apparatus of claim 1 wherein said Vacuum Accelerator (6) comprises a hose produced from plastic resistant to high heat having with a 1 mm inside diameter and a length of 3 meters.

7. The apparatus of claim 1 wherein said Reducer I (5) comprises a piece produced from plastic resistant to high heat having a 1 mm inside diameter and 1 cm length.

8. The apparatus of claim 1 wherein said Acoustic Pump (3) comprises a piece produced from plastic resistant to high heat, having a 4.5 cm outside body diameter and 5.5 cm length, said Acoustic Pump having air entry and exit holes of 5 mm diameter at both ends and a Filter (4) inside.

9. The apparatus of claim 1 wherein said Aluminum Lid I (2) and said, Aluminum Lid II (11) close to both ends of Aluminum Pipe (12).

10. The apparatus of claim 1 wherein said Apparatus provides fuel economy through air feed in 4 gear internal combustion engines connected to the air suction manifold directly or in parallel with the assistance of a T pipe connection.
